(19) United States
(12) Patent Application Publication
(10) Pub. No.: US 2015/0013095 A1
(43) Pub. Date: Jan. 15, 2015

(54) CONNECTION MOUNT, MECHANICAL CONNECTOR AND WIPING DEVICE FOR A MOTOR VEHICLE

(71) Applicant: Gérald Caillot, Cernay La Ville (FR)

(72) Inventor: Gérald Caillot, Cernay La Ville (FR)

(73) Assignee: VALEO SYSTÈMES D'ESSUYAGE, Le Mesnil Saint Denis (FR)

(21) Appl. No.: 14/117,239

(22) PCT Filed: Apr. 17, 2012
(86) PCT No.: PCT/EP12/56968

§ 371 Date: Sep. 30, 2014

(30) Foreign Application Priority Data
May 12, 2011 (FR) 1154098

(51) Int. Cl. B60S 1/34

(52) U.S. Cl. CPC B60S 1/3431
USPC 15/250.34

(57) ABSTRACT

The present invention relates to a connection mount comprising a support (9; 38) intended to callaborate with an adaptor (18a, 18b, 18c) that can be connected to an actuating arm (7a, 7b, 7c, 7d, 7e, 7f) of a motor vehicle wiper device and that can collaborate with this adaptor (18a, 18b, 18c) to bold and attach a wiper blade (2; 31) to the actuating arm (7a-7f), characterized in that said connection mount (3; 34) also comprises at least one washer fluid dispenser (4a, 4b; 35) having at least one inlet (14, 15; 36) that can be inserted into a bore of a washer fluid carrying pipe belonging to the actuating arm (7a-7l). The present invention also relates to a mechanical connector for a motor vehicle wiper blade and to a wiping device.

The present invention relates to a connection mount intended to collaborate with an adapter able to be connected to an actuating arm of a motor vehicle wiper device in order therewith to form a mechanical connector for bearing a wiper blade and attaching it to the actuating arm.

Wiper blades comprise means of connection so that they can be coupled to a suitably shaped actuating arm. It will be recalled in this regard that there are various kinds of arm, for example arms with hooks, arms with side pins, arms with push buttons/sliders, arms with pinch tabs, etc.

Be that as it may, wiper blades of today have the disadvantage of not being standardized, notably in terms of the means of connection supposed to couple them to the actuating arm. In practice, there are thus as many kinds of flat wiper blades as there are different arms, not to mention the matter of blade length for wiping all of the area of windshield that needs to be wiped. In addition, for any given category of wiper blades there are a multitude of different modes of embodiment caused by the multitude of manufactures competing in this market. This is why ultimately there are such a great many flat wiper blades incorporating means of connection that are specific to a given type of actuating arm.

Document WO 2008/145481 discloses a connector that is compatible with various types of actuating arm for attaching a flat wiper blade.

The present invention seeks to offer a connector that is compatible with various types of actuating arm, which can also be fitted to the new-generation and old-generation wipers, such as flat blades or wipers with single or double spray bars (also referred to as AquaBlade®).

To this end, one subject of the present invention is a connection mount comprising a support intended to collaborate with an adapter able to be connected to an actuating arm of a motor vehicle wiper device and able to collaborate with this adapter to bear a wiper blade and attach it to the actuating arm, characterized in that said connection mount further comprises at least one washer fluid distributor having at least one inlet that can be inserted into a canal of a washer fluid conveying pipe of the actuating arm.

According to one or more features of the connection mount, considered alone or in combination:
the washer fluid distributor and the support are formed as a single piece;
the washer fluid distributor is an element distinct from the support, fixed to one side of the support;
the washer fluid distributor is attached by clip fastening or by bonding or by ultrasonic welding;
the washer fluid distributor has at least one outlet that can be inserted into a canal of a support fixture or the wiper blade;
the support has an elongate shape and the washer fluid distributer has two outlets respectively opening at each opposite end of the support;
the washer fluid distributor comprises a straight tube communicating between the outlets and an inclined tube communicating with the straight tube and with the inlet and forming an acute angle with the straight tube in a plane perpendicular to the overall plane of the connection mount;
the washer fluid distributor comprises a straight tube communicating between the outlets and an inclined tube communicating with the straight tube and with the inlet and forming an acute angle with the straight tube in an overall plane of the connection mount;
the support comprises a retaining guide for a first end of the adapter and removable means of attachment of a second end of the adapter, and the inclined tube meets the straight tube on the side of the support that bears the removable means of attachment;
the retaining guide is formed by two lateral wall portions and two transverse wall portions of the support which are arranged in such a way as to form two receiving housings able to accept associated side pins of a first end of the adapter to form a pivot connection, and at least one washer fluid distributor is housed in a lateral wall of the support partially forming the retaining guide for the adapter;
the washer fluid distributor comprises a plurality of outlets fitted with jets arranged as a spray bar.

The standard interface of the connection mount and of the adapter means that any type of wiper can be mechanically connected to any type of actuating arm. The washer fluid distributor also allows the pipe in the actuating arm to be connected to one or more spray orifices arranged at the mechanical connector or at the wiper. The spray orifices can therefore move at the same time as the wipers move.

The mechanical connector is thus universal and allows the washer fluid to be distributed to any type of wiper or actuating arm.

Another subject of the invention is a mechanical connector for a motor vehicle windshield wiper, characterized in that it comprises a connection mount as described hereinabove and an adapter able to be connected to an actuating arm of a motor vehicle wiper device, the adapter being able to collaborate with said connection mount to bear a wiper and attach it to the actuating arm.

A further subject of the invention is a wiper device, characterized in that it comprises a wiper attached and borne by a mechanical connector as described hereinabove.

According to one embodiment of the wiper device,
the wiper comprises a blade rubber, a frame, an internal backing strip and two support fixtures surmounting the blade rubber, the support fixtures being arranged on either side of the mechanical connector,
at least one spray bar is formed longitudinally in the support fixture, and
at least one washer fluid circulation canal, communicating with the spray bar, is formed in each support fixture.

Further features and advantages of the invention will become apparent from the following description given by way of nonlimiting example with reference to the attached drawings in which:

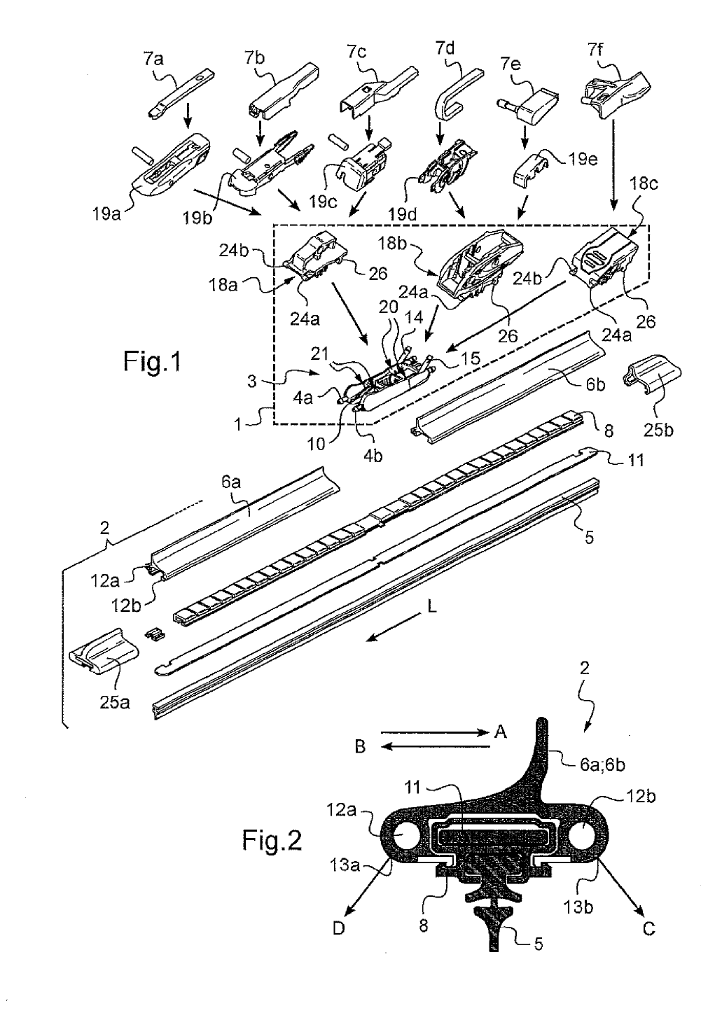

FIG. 1 is a schematic exploded view of a “double spray bar” wiper, a connection mount for this wiper and various associated actuating arms and adapters that can be connected to this same connection mount,

FIG. 2 is a view in cross section of a “double spray bar” wiper on a glazed surface,

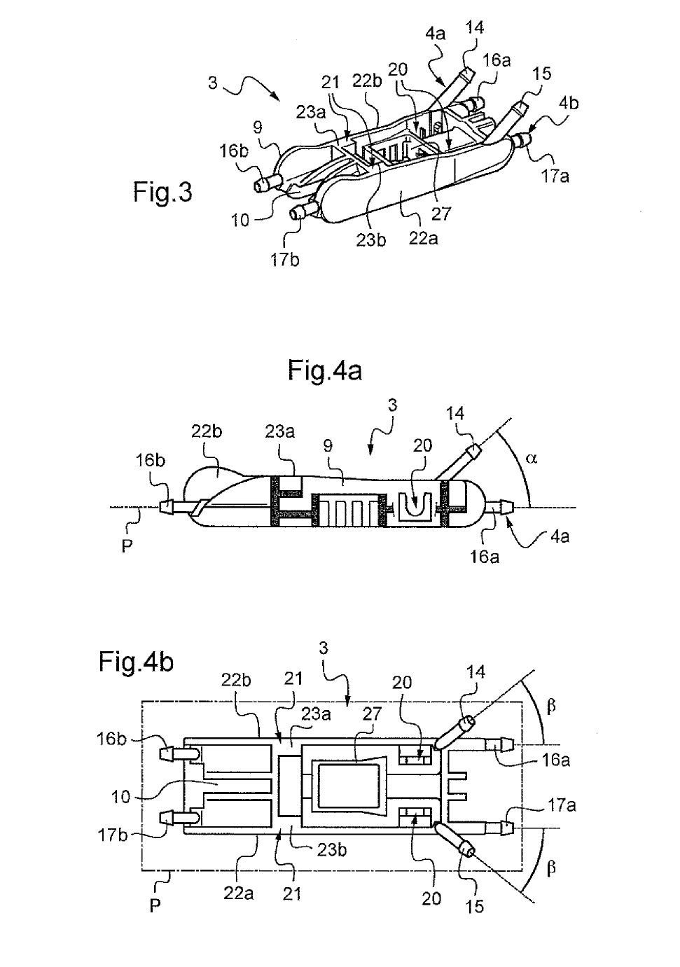

FIG. 3 is a detailed perspective view of the connection mount of FIG. 1,

FIG. 4a depicts a schematic side view of the connection mount of FIG. 3, in cross section,

FIG. 4b depicts a schematic view of the connection mount of FIG. 3, from above,

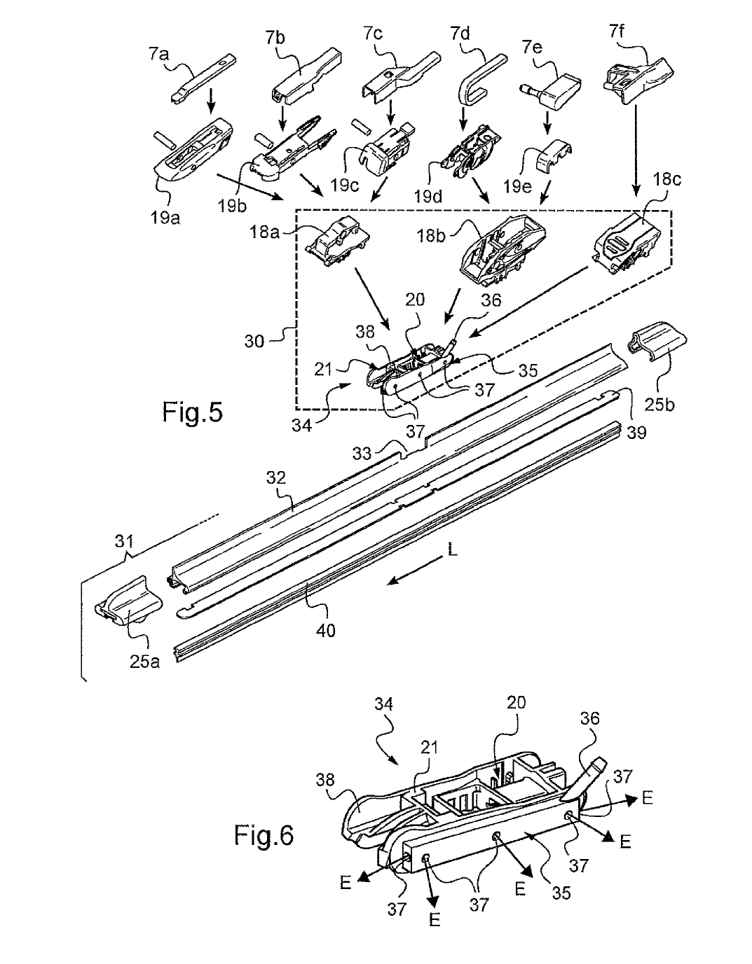

FIG. 5 shows an exploded schematic view of a “simple” wiper, a connection mount according to a second embodiment for this wiper and various associated actuating arms and adapters that can be connected to this same connection mount, and

FIG. 6 is a detailed perspective view of the connection mount of FIG. 5.

In these figures, elements that are identical bear the same reference numerals.

FIGS. 1 to 3, 4a and 4b depict a first embodiment of a mechanical connector 1 suited to a “double spray bar” type of wiper blade 2 (also referred to as an AquaBlade®).

In the condition in which it is assembled on the motor vehicle, the wiper blade 2 is borne by and attached to an actuating arm 7a, 7b, 7c, 7d, 7e or 7f of a vehicle wiper device using the mechanical connector 1.

For that purpose the mechanical connector 1 comprises a connection mount 3 and an adapter 18a, 18b or 18c connected to an actuating arm 7a-7f. The adapter 18a, 18b or 18c collaborates with a support 9 of the connection mount 3 to hold the wiper blade 2 on an actuating arm 7a-7f.

More specifically, the wiper blade 2 is mounted atop the actuating arm 7a through the interposition of an intermediary component 19a which is connected to the adapter 18a which collaborates with the connection mount 9. Alternatively, the wiper blade 2 is mounted atop the actuating arm 7b through the interposition of an intermediary component 19b which is connected to the same type of adapter 18a able to collaborate with the connection mount 9. Likewise the wiper blade 2 is mounted atop the actuating arm 7c through the interposition of an intermediary component 19c which may be connected to the same adapter 18a and able to collaborate with the connection mount 9. The wiper blade 2 is mounted atop the actuating arm 7d through the interposition of an intermediary component 19d which may be connected to a second type of adapter 18b able to collaborate with the connection mount 9. The wiper blade 2 is mounted atop the actuating arm 7e by the interposition of an intermediately component 19e able to be connected to the adapter 18b which can collaborate with the connection mount 9. Finally, the wiper blade 2 is mounted atop the actuating arm 7f without any intermediary component with a third type of adapter 18c able to collaborate with the connection mount 9.

For each type of attachment of the actuating arm 7a-7f, for example arms with hooks, arms with side pins, arms involving push buttons/sliders, arms with pinch tabs, etc., there may be a special purpose intermediary component and a special purpose adapter, but each of these adapters 18a, 18b, 18c can be fitted to the same connection mount 3 via a standard interface.

The double spray bar wiper blade 2 extends longitudinally in the direction L. It comprises a blade rubber 5, a plastic frame 8, an internal metal backing strip 11 and two support fixtures 6a, 6b surmounting the blade rubber 5.

Better visible in FIG. 2, the blade rubber 5 has a longitudinal narrowing referred to as the hinge, that allows it to pivot with respect to the longitudinal axis L each time it changes direction as the blade 2 is operated by the actuating arm against the glazed surface (see arrows A and B).

Returning back to FIG. 1 it may be seen that the two support fixtures 6a, 6b are mounted on the frame 8 into which the blade rubber 5 is fitted. The support fixtures 6a, 6b are mounted one on each side of the mechanical connector 1, itself arranged approximately in the middle of the wiper blade 2. The support fixtures 6a, 6b have a special aerodynamic shape allowing them to act like a “spoiler” with a view to improving the adhesion of the blade 2 to the glazed surface. According to the embodiment depicted, the support fixtures 6a, 6b have a longitudinal housing for the internal backing strip 11 and for the blade rubber 5. The support fixtures 6a, 6b may be as a single piece and of a different material from that of the blade rubber 5. They are, for example, coextruded using two different materials.

The support 9 of the connection mount 3 (FIGS. 3, 4a and 4b) has an elongate shape intended to bear the frame 8 and the backing strip 11 in a holding canal 10 passing longitudinally through the support 9. For that, the holding canal 10 of the support 9 has shapes suited to fitting together with a corresponding shape of the internal backing strip 11. The assembly comprising the support fixtures 6a, 6b, the frame 8, the internal backing strip 11 and the blade rubber 5 is kept assembled by end clip means 25a, 25b of the wiper blade 2.

Each support fixture 6a, 6b of the double spray bar wiper blade 2 comprises two washer fluid circulation canals 12a, 12b formed one on each side of the blade rubber 5. Each circulation canal 12a, 12b opens via an associated spray bar 13a, 13b formed longitudinally in the support fixture 6a, 6b. The spray bars 13a, 13b are provided with one or with a multitude of pressurized spray orifices or jets (or nozzles) that allow the washer fluid to be distributed directly onto the glazed surface (see arrows C and D in FIG. 2).

The connection mount 3 further comprises two washer fluid distributors 4a, 4b. Each washer fluid distributor 4a, 4b has an inlet 14, 15 and two outlets 16a, 16b and 17a, 17b.

The wiper device further comprises a pipe for conveying washer fluid which pipe is borne by the actuating arm 7a-7f (the pipe is not depicted). The pipe comprises, for example, a rubber sleeve in which two circulation canals are formed and into which the two inlets 14, 15 of the two distributors 4a, 4b are respectively inserted. The canals in the pipe are moreover connected to a two-way pump or to two one-way pumps of the wiper device.

The outlets 16a, 16b and 17a, 17b of each distributor 4a, 4b open respectively at each opposite end of the support 9 (FIGS. 1, 3, 4a and 4b). The outlets 16a, 16b and 17a, 17b can be inserted into the respective circulation canal 12a, 12b of the respective support fixture 6a, 6b of the wiper blade 2.

The inlets 14, 15 and the outlets 16a, 16b, 17a, 17b may have quick-fit connectors. As may be seen in FIG. 3, the quick-fit connectors comprise annular ribs, of substantially frustoconical form making connection to the circulation canals of the pipe and of the support fixtures 6a, 6b easier and allowing this connection to hold securely.

According to an alternative mode of embodiment that has not been depicted, the inlets 14, 15 of the distributors 4a, 4b and the pipe have complementary connectors. These complementary connectors make fitting easier and make it possible to “make up for” the difference between the spacing of the inlets 14, 15 and the spacing of the canals in the pipe.

More specifically, the first washer fluid distributor 4a comprises a straight tube communicating between the outlets 16a and 16b and an inclined tube communicating with the inlet and the straight tube, forming an acute angle a with the straight tube in the vertical plane, i.e. one substantially perpendicular to the overall plane P of the connection mount, parallel to the glazed surface (FIG. 4a). Likewise, the second washer fluid distributor 4b comprises a straight tube communicating between the outlets 17a and 17b and an inclined tube communicating with the inlet 15 and the straight tube, forming an acute angle with the straight tube.

The tubes inclined by an acute angle a make it possible to reduce stresses at the connection between the pipe and the connection mount 3, as the conveying pipe is guided by the actuating arm.

Likewise, provision may be made for the inclined tubes to form an acute angle p with the straight tube of the respective distributor 4a, 4b in the overall plane P of the connection mount 3 (FIG. 4b).

The tubes inclined by an acute angle p make it possible to free up lateral space in the connection mount 3 making it easier to connect the adapter 18, 18b, 18c to the connection mount 3.

The washer fluid distributors 4a, 4b are, for example, made as a single piece with the support 9. The connection mount 3 is, for example, made of plastic and obtained by molding.

The connection mount 3 is intended to be fixed to an adapter 18a, 18b, 18c that likewise has an elongate shape with a first end and a second end. The adapter 18a, 18b, 18c is able to be connected, directly or via an additional component 19a, 19b, 19c, 19d or 19e to the actuating arm 7a-7f. As can be seen in FIG. 1, the adapter 18a, 18b, 18c is attached to the opposite face of the mount 3 to the face that has the canal 10 that holds the blade rubber 5.

On its upper face, the adapter 18a, 18b, 18c is surmounted by a fastener for the actuating arm. FIG. 1 depicts a connection mount 1 that suits three types of adapter 18a, 18b, 18c which can be fitted directly or via components 19a-19e to the various types of actuating arms 7a-7f depicted in a row at the top of the figure, namely, from left to right: three different arms involving push button/clipping/longitudinal fastening 7a, 7b, 7c, one hook-ended arm 7d, and two side pin arms 7e, 7f. Thus, the connection mounts 1 are standardized components that are used with all types of actuating arm.

To attach the adapter 18a, 18b, 18c to the mount 3 there are first means 20 of attachment for holding the first end of the adapter and second means 21 of attachment for holding the second end of the adapter 18a, 18b, 18c.

The first means of attachment comprise, in the support 9 of the mount 3, a retaining guide 20 for retaining the first end of the adapter. More specifically, the retaining guide 20 is achieved firstly by lateral wall portions 22a, 22b of the support 9 which provide lateral guidance to said first end and secondly by transverse wall portions 23a, 23b of the support 9, which are perpendicular to the lateral walls 22a, 22b, preventing said first end from moving in a direction perpendicular to the overall plane P defined by said mount 1.

The mount walls 22a, 22b, 23a, 23b are arranged in such a way as to form two receiving housings able to receive associated cylindrical side pins 24a, 24b belonging to the first end of the adapter 18a, 18b, 18c. The pins 24a, 24b of the adapter 18a, 18b, 18c inserted in the receiving housings form a pivot connection.

Provision is thus made for a washer fluid distributor 4a, 4b to be housed in each side wall 22a, 22b of the support 9 partially forming the retaining guide for the adapter.

The second means 20 of attachment are, for example, produced in the form of complementary removable means of attachment, the second end having complementary removable means of attachment intended to collaborate with removable means of attachment belonging to the support 9 of the connection mount 3. More specifically, the complementary removable means of attachment are, for example, formed of clipping means comprising, for example, two forked elastic arms able to receive an associated peg 26 secured to the adapter 18a, 18b, 18c. Two peg-arm pairs for example are provided.

Provision is also made for the inclined tubes, of each distributor 4a, 4b, to meet the straight tube on the side of the support 9 that bears the removable means of attachment 20.

The mount 3 may further comprise a centering shape 27 able to collaborate with a complementary shape of the adapter, produced for example in the form of a square opening into which a complementary square-shaped protrusion borne by the adapter can be inserted. At rest and in the assembled state, the wiper blade 2 and its connection mount 3 exhibit a longitudinal plane of symmetry.

Upon assembly, the frame 8 is mounted in the connection mount 3 by making the shapes of the frame 8 coincide in the holding canal 10. The inner backing strip 11 is then mounted in the frame 8 by sliding it in the cutouts in the frame 8 until it becomes immobilized in the holding canal 10.

The outlets 16a, 16b, 16c, 16d of the connection mount 3 are then inserted into the support fixtures 6a, 6b that are mounted on the frame 8. The end clipping means 25a, 25b are clipped on. Next, the pins 24a, 24b of the first end of the adapter 18a, 18b or 18c are inserted into the receiving housings. Thus, the pins 24a and 24b pass under the transverse walls 23a and 23b and are guided laterally by the lateral walls 22a and 22b of the support 9. Then, following insertion, a pivoting movement is begun in order to bring the clip fastening means 20, 26 to face one another and thereafter engage with one another.

The double spray bar wiper blade 2 can thus be coupled to any actuating arm of suitable shape.

The washer fluid picked up by the pump can then circulate through the pipe along the actuating arm, be supplied to distributors 6a, 6b which, in turn, send the washer fluid into the circulation canals 12a, 12b of the support fixtures 6a, 6b of the blade. The liquid can then be distributed along the wiper blade 2, on each side of the blade rubber 5 and only on the front part of the blade, i.e. on the spray bar 13a situated on the side in which the actuating arm 7a-7f advances during a downstroke of the wiping (arrows B and D in FIG. 2) and on the other side (spray bar 13b) during the upstroke of wiping (arrows A and C). This arrangement allows the washer fluid to be wiped immediately after it has been applied to the glazed surface, thus eliminating any space of time during which visibility may have been reduced.

According to other forms of embodiment that have not been depicted, the distributors are fixed on the sides of the distributor by bonding, ultrasonic welding or clip fastening.

It is also possible to conceive of the connection mount comprising a single washer fluid distributor fixed or integrated into one side of the support. Such an embodiment would be particularly suitable for a simple or single spray bar wiper blade the support fixture which has just one distribution canal equipped with one spray bar. Spraying is then performed on just one side of the blade and the wiper device has just one one-way pump.

In such a case, provision may also be made for the inlet of the distributor 4a to be positioned on one side of the support. The end of the pipe and the inlet may have complementary connectors.

FIGS. 5 and 6 depict another embodiment of a mechanical connector 30 for what is referred to as a “flat blade” wiper 31 the support fixture 32 of which comprises neither in-built spray bars nor washer fluid circulation canals.

Only those elements which differ from the first embodiment are described hereinafter.

In this second embodiment, the wiper blade 31 comprises a single support fixture 31 extending longitudinally along the entire length of the blade. The support fixture 32 has, more or less in its middle, a cutout shape 32 revealing the internal backing strip 39 for immobilizing the latter in the shapes of the support of the connection mount 34 of the mechanical connector 30.

The connection mount 34 comprises a washer fluid distributor 35 having an inlet 36 that can be inserted into a canal of a washer fluid conveying pipe of the actuating arm 7a-7f and a plurality of outlets 37 fitted with pressurized spray orifices or jets arranged as a spray bar. In the example illustrated in FIG. 6, the distributor 35 thus has five outlets 37 able to send washer fluid forward and backward (longitudinally) and along one side of the wiper blade 31 (see arrows E).

The washer fluid distributor 35 is, for example, an element distinct from the support 38. It is for example attached to one side of the support 38 by clip fastening or by bonding or by ultrasonic welding.

The washer fluid can thus be distributed at the mechanical connector 30 on one side of the actuating arm 7a-7f.

It is also possible to conceive of the connection mount having two washer fluid distributors equipped with a plurality of outlets arranged in a spray bar, fixed on each side of the support or made as a single piece with the support (this is not depicted).

The support 38 of the mount 34 moreover comprises the same means of attachment to the adapter 18a, 18b, 18c as in the first embodiment.

It will be appreciated that, with a mechanical connector comprising a washer fluid distributor, it is possible to couple any type of wiper blade to any actuating arm.

The mechanical connector 30 is designed to be mounted on a wiper blade 2, 31 having a single backing strip 11, 39 structure.

Quite obviously, the ability to fit the mechanical connector 30, for assembly to an actuating arm, to a wiper blade having a structure in which the blade rubber has two metal backing strips is also planned.

Such wiper blade structures with two metal backing strips are known in the prior art and do not need to be set out in greater detail.

1. A connection mount comprising:
a support intended to collaborate with an adapter connected to an actuating arm of a motor vehicle wiper device and able to collaborate with the adapter to bear a wiper blade and attach it to the actuating arm;
first attachment means for holding a first end of the adapter and second attachment means for holding a second end of the adapter; and
at least one washer fluid distributor having at least one inlet that can be inserted into a canal of a washer fluid conveying pipe of the actuating arm.

2. The connection mount as claimed in claim 1, wherein the washer fluid distributor and the support are formed as a single piece.

3. The connection mount as claimed in claim 1, wherein the washer fluid distributor is an element distinct from the support.

4. The connection mount as claimed in claim 3, wherein the washer fluid distributor is attached by clip fastening.

5. The connection mount as claimed in claim 2, wherein the washer fluid distributor has at least one outlet that can be inserted into a canal of a support fixture or the wiper blade.

6. The connection mount as claimed in claim 5, wherein the support has an elongate shape and in that the washer fluid distributer has two outlets respectively opening at each opposite end of the support.

7. The connection mount as claimed in claim 6, wherein the washer fluid distributor comprises a straight tube communicating between the outlets and an inclined tube communicating with the straight tube and with the inlet and forming an acute angle (α) with the straight tube in a plane perpendicular to the overall plane (P) of the connection mount.

8. The connection mount as claimed in claim 7, wherein the washer fluid distributor comprises a straight tube communicating between the outlets and an inclined tube communicating with the straight tube and with the inlet and forming an acute angle (β) with the straight tube in an overall plane (P) of the connection mount.

9. The connection mount as claimed in claim 8, wherein the support comprises a retaining guide for a first end of the adapter and removable means of attachment of a second end of the adapter, and in that the inclined tube meets the straight tube on the side of the support that bears the removable means of attachment.

10. The connection mount as claimed in claim 9, wherein the retaining guide is formed by two lateral wall portions and two transverse wall portions of the support which are arranged in such a way as to form two receiving housings able to accept associated side pins of a first end of the adapter to form a pivot connection, and in that at least one washer fluid distributor is housed in a lateral wall of the support partially forming the retaining guide for the adapter.

11. The connection mount as claimed in claim 1, wherein the washer fluid distributor comprises a plurality of outlets fitted with jets arranged as a spray bar.

12. A mechanical connector for a motor vehicle windshield wiper, comprising:
a connection mount as claimed claim 1; and
an adapter able to be connected to an actuating arm of a motor vehicle wiper device, the adapter being able to collaborate with said connection mount to bear a wiper and attach it to the actuating arm.

13. A wiper device, comprising a wiper that is attached and borne by a mechanical connector as claimed in claim 12.

14. The wiper device as claimed in claim 13, comprising
a wiper, the wiper comprising a blade rubber, at least one backing strip, and at least one support fixture surmounting the blade rubber, wherein at least one spray bar is formed longitudinally in the support fixture, and in that at least one washer fluid circulation canal, communicating with the spray bar, is formed in the support fixture.

15. The wiper device as claimed in claim 13, comprising:
a wiper, the wiper comprising a blade rubber, a frame, an internal backing strip and two support fixtures surmounting the blade rubber, the support fixtures being arranged on either side of the mechanical connector, wherein at least one spray bar is formed longitudinally in the support fixture, and at least one washer fluid circulation canal, communicating with the spray bar, is formed in each support.
